(19) United States
(12) Patent Application Publication
(10) Pub. No.: US 2009/0166048 A1
(43) Pub. Date: Jul. 2, 2009

(54) SOIL-WORKING IMPLEMENT WITH CRANK PROTECTION

(75) Inventor: Georg Wiedenmann, Rammingen (DE)

Correspondence Address: Novak Druce + Quigg, LLP, 1300 Eye Street, NW, Suite 1000, Suite 1000, West Tower, Washington, DC, 20005, US

(73) Assignee: WIEDENMANN GMBH, Rammingen (DE)

(21) Appl. No.: 12/094,268

(22) PCT Filed: Oct. 26, 2006
(86) PCT No.: PCT/DE2006/001893

§ 371 Date: Nov. 10, 2008

(30) Foreign Application Priority Data
Nov. 21, 2005 (DE) 10 2005 055 289.7

(51) Int. Cl. A01B 45/02; A01B 67/00

(52) U.S. Cl. 172/21; 172/103

(57) ABSTRACT

The invention relates to a soil-working implement (1, 2) for subsoiling (22), having a series of carrying arms (25), of which each is mounted by way of a first region, in particular a first end region, on an implement frame (20) or an implement chassis such that it can be pivoted up and down about a first pivot axis (26), having a crankshaft (34) with at least one crankshaft journal (38), having in each case at least one cutting tool articulation device (30) for articulating a cutting tool (32) on a second region, in particular a second end region, of each carrying arm (25), and having at least one crank connecting device (29) per carrying arm (25), this device connecting the cutting tool articulation device (30) to the at least one crankshaft journal (38) of the crankshaft (34) for the purpose of driving the up and down movement guided by the carrying arm (25). In order to improve the soil-working implement such that adverse effects of the cutting tools striking against obstructions can be minimized, and nevertheless smaller moving masses can be provided, it is proposed that the crank connecting device (29) has an uncoupling device (42) which, at least in the case of overloading between the crankshaft (34) and the cutting tool articulation device (30), allows relative movement of the cutting tool articulation device (30) in the direction of the crankshaft journal (38).

The invention relates to a soil-working implement for subsoil loosening having the features as set forth in the preamble of the attached claim 1.

Such soil-working implements are marketed in a wealth of different versions as known from a plurality of patent documents, such as, for example, DE 196 55 123 C2, WO 98/05191, EP 1 040 741 A2, EP 0 853 869 B1, JP-A-55-89538, EP 0 037 595 A1 as well as particularly EP 1 208 730 A1.

The basic principle of subsoil aerators as an example of such implements reads, for instance, from EP 0 853 869 B1 describing how these soil-working implements are travelled over the ground hitched, for example, to a tractor. For example, the implement can be hitched to a reciprocating three-point linkage of a tractor or hitched to trail a traction vehicle. As a rule, soil-working implements feature an implement frame (also termed implement chassis) which can roll over the ground mostly by means of wheels, rollers or cylinders or the like. The soil-working implements involved comprise transversely to the forwards (travel) direction an inline arrangement of tool units for working the soil, each of which has (at least) one carrying arm hinge mounted on the implement chassis for raising and lowering about this hinge mount via a crank assembly, a spike tool being pivotably hinged to the other end of the carrying arm.

As a rule the crank assembly comprises a crankshaft with at least one crankshaft journal at which a crank connecting assembly in the form of a rigid con rod or rigid pitman—also sometimes termed power rod—is rotatably articulated mounted. Pivotably hinged to the other end of the con rod or pitman is the carrying arm.

For hinge-mounting the tools a tool holder is provided, as a rule, as a spike articulation assembly in which a spike such as for example a tine or group of tines or a hollow spoon or spike assemblies in the form of a bed of nails is securely fastened. These tool holders are pivotably hinged to the carrying arm.

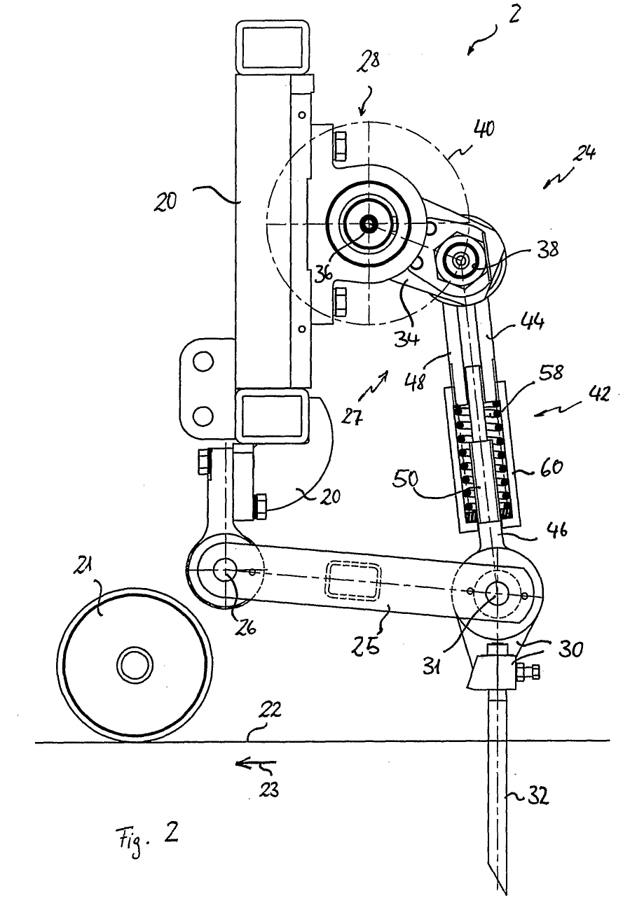

As evident from FIGS. 2 and 3 of EP 0 853 869 B1 and as it reads from the corresponding description the spikes enter the soil on the lowering motion of the carrying arm on this particularly type of aerators involved. In further travel of the implement the spikes initially remain in the soil in the bottom position of the carrying arm and are pivoted relative to the carrying arm by the resistance they meet with, resulting in the spike articulation assembly being pivoted relative to the carrying arm. Provided furthermore as a rule for each spike and spike holder is a stop against which the spike and respectively its holder is pretensioned by a biasing means. In the pivoting action of the spike articulation assembly relative to the carrying arm the spike articulation assembly or an element pivotably hinged thereto leaves the corresponding stop in further travel of the implement with the spike still in the soil. When the carrying arm is then returned raised and the spike lifted from the soil by the raising motion on further travel of the soil-working implement, the bias assembly returns the spike articulation assembly against the stop.

Such soil-working implements are often employed on sports fields where the ground may be trampled relatively compact from the sports activities as is particularly the case with soccer pitches or the teeing off locations on golf courses. It is here that deep subsoil loosening is important to maintain the turf hardy despite such rough treatment. It will readily be appreciated that such compacted locations require each spike to be powered relatively strongly to penetrate the ground. This is why the crankshafts and links need to be engineered particularly rugged, rigid and massive.

In operation it may happen that the spike encounters an obstacle in the soil, for instance a stone or root, which may jolt the soil-working implement as a whole. These jolts are transmitted via the soil-working implement to the traction vehicle, stressing the system in its entirety. This is why with many of the known soil-working implements only a relatively low working speed is attainable, because faster working would overtax the system when obstacles encountered in the soil add to the stress of aerating such compacted locations.

To alleviate jolting and avoid damage in operation, special dampers are fitted to soil-working implements as a known, for example, from JP-A-55-89538 and EP 1 208 730 A1.

Provided on the soil-working implement as it reads from JP-A-55-89538 are two carrying arms in parallel, engineered extensible in overcoming a spring bias in thus enabling the spike when encountering an obstacle to pivot out of the way thereof. However, this design is particularly complicated, for one thing, and, for another, the pivoting action all depends on the obstacle involved, the angle of impact and the shape of the obstacle. When, for instance, the spike comes up against a flat surface of a stone more or less vertically, it cannot be pivoted out of the way and the jolt is transmitted with its full force via the crank assembly through the soil-working implement to the tractor. In addition to this, because of two carrying arms being provided, a massive weight needs to be raised and lowered, this in itself making for shaky operation of the known soil-working implement.

By contrast, the soil-working implement as disclosed by EP 1 208 730 A1 features a damper on an upper link connection of the implement. When jolted by an obstacle the soil-working implement turns about its lower link connection, but this action is absorbed by the damper in thus preventing it being transmitted to the traction vehicle. Although this achievement has a proven record of success in operation, especially by achieving much higher working speeds, the risk still remains of the PTO train being damaged by heavy jolts. Despite this being encountered by a correspondingly rugged design of the PTO train, including crank assembly/rod and carrying arm, it involves having to produce, handle and move relatively weighty items.

On the basis of prior art as it reads from EP 1 208 730 A the object of the invention is to sophisticate a soil-working implement as set forth in the preamble of the attached claim 1, such that when the spikes encounter obstacles the risk of damage and/or any other unwanted consequences are now minimized whilst making for smaller moved masses being provided.

This object is achieved by a soil-working implement having the features of the attached claim 1.

Advantageous aspects of the invention are the subject matter of the sub-claims.

In accordance with the invention a soil-working implement is thus provided for subsoil loosening, having an in-line arrangement of carrying arms, each of which is mounted by way of a first portion—as a rule by a first end portion—on an implement frame or an implement chassis such that it can be pivotably raised and lowered about a first pivot axis. Provided further is a crankshaft with at least one crankshaft journal for powering the raising and lowering motion whilst at a second portion, particularly at a second end portion each carrying arm features in each case at least one spike articulation assembly for articulating a spike. Such a spike articulation assembly may be formed e.g. by the tool holder as explained above. At least one crank connecting assembly is provided per carrying arm, this assembly connecting the spike articulation assembly to the at least one crankshaft journal of the crankshaft for the purpose of activating raising and lowering guided by the carrying arm. Preferably the crank connecting assembly engages at one end the crankshaft journal and at the other end the carrying arm so as to indirectly connect the spike articulation assembly via the carrying arm to the crankshaft, although it would be just as possible to provide a direct connection of the spike articulation assembly with the crankshaft.

In accordance with the invention the crank connecting assembly is further provided with an uncoupling assembly which, at least when overloaded between the crankshaft and the spike articulation assembly allows relative movement of the spike articulation assembly in the direction of the crankshaft journal. In other words, whilst in prior art the crankshaft journal is connected by a rigid drive rod or con rod to the carrying arm and thus to the spike articulation assembly, in accordance with the invention a means of uncoupling is now provided between the spike articulation assembly and the crankshaft at least when the implement is overloaded. Thus when the spike encounters a stone or the like in operation it firstly transmits the jolt to the spike articulation assembly from where it is communicated to the uncoupling assembly. When this involves an overload the uncoupling assembly complies so that the jolt is not transmitted to the crankshaft in its full intensity in thus already providing overload protection for the crankshaft and thus also for the upstream components in the PTO train so that it can now be engineered less complicated and rigid.

The uncoupling assembly may comprise a resilient damper permitting resilient compliance and/or a non-resilient damper which snaps when overloaded and/or becomes permanently deformed. Preference is given to a resilient damper such as, for example, a compression spring or the like. Such a spring is capable of initially taking the severe jolts in thus preventing the PTO train from being overloaded. But a certain damping also occurs already with less severe jolts so that the crankshaft has smoother overall operation under normal circumstances. Engineering the damper in this way also makes for faster operation and a higher spiking frequency.

A damper which reacts by becoming permanently deformed or snapping is provided to avoid damage due to severe jolts and is active only when spiking is overloaded. When the spike encounters an obstacle, causing a severe jolt, resulting in a force being applied to the crank connecting assembly which exceeds a critical force threshold, the non-resilient damper snaps or is permanently deformed, meaning it needs to be replaced new. But this makes for a very simple solution to avoiding major damage to the soil-working implement, whilst such a damper is easily to access and to be replaced.

Yet another embodiment of the invention is, so to speak, a go-between between a fully resilient damping and a fully non-resilient damping in which the uncoupling assembly comprises a latch which releases when spiking is overloaded. A severe jolt releases the latch so that the jolt is not relayed to the crankshaft, the latch being automatically reinstated on the next raising motion, or manually by the operator.

In another concrete aspect it is provided for that the crank connecting assembly comprises a first drive member pivotably hinged to the crankshaft journal, the crank connecting assembly furthermore comprising a second drive member pivotably hinged to the carrying arm. These first and second drive members may be engineered e.g. as rods or simply comprising corresponding mounts and supports. Included furthermore is an assembly in which both first and second drive members are coupled to each other by the uncoupling assembly, preferably actioned in that they being more or less rigidly connected until overloaded. This rigid connection my be achieved e.g. by a spring or very stiff spring constants (resilient damper) or by a link which snaps when overloaded, for instance a rod made of fiber glass with a designed frangible location or by a permanently deformed damper, for example like a structure as is provided for in automomotive steering columns, e.g. featuring a tube made of perforated sheet metal which when overloaded can be concertined or by a latch being provided between the first and second drive members. Where needed, it is also possible that a combination of these various dampers/links may be provided either connected in parallel or preferably connected in series.

The two drive members may be, for example, parts of a telescopically extensive power rod, although they could also be pivotably interconnected. For example, the two drive members are rod-type elements or mounting elements which are pivotally coupled to each other at their interengaging ends and are defined in an obtuse angle by the the damper or link so that when overloaded the two drive members pivot to each other by permanently deformed or snapping of the damper or with release of the latch, the obtuse angle then dictating the direction of deformation.

Example aspects of the invention will now be detained with reference to the attached drawings in which

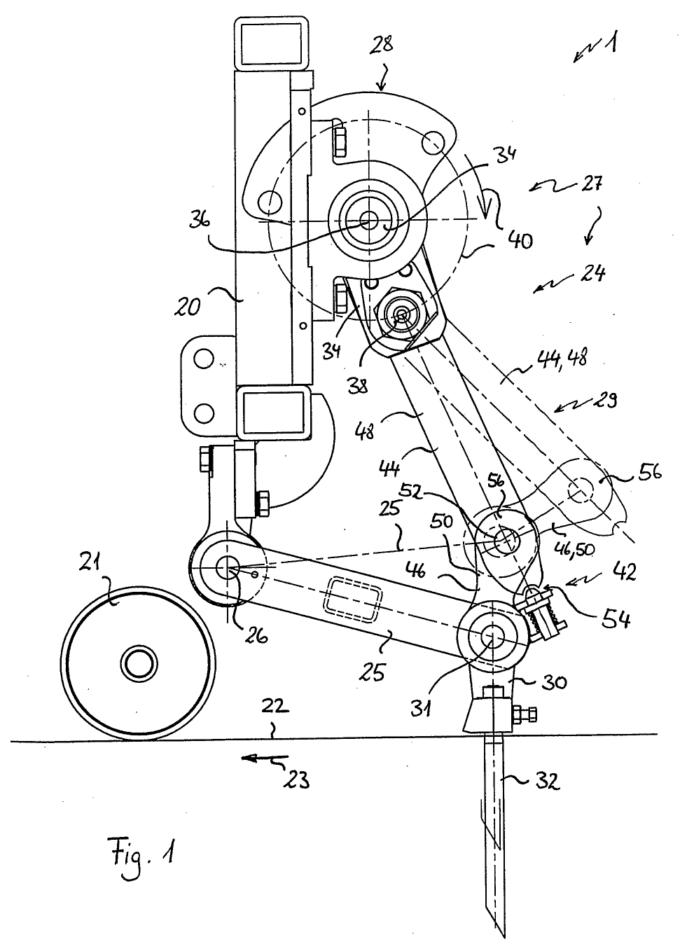

FIGS. 1 and 2 are like side views of the essential components of two embodiments of soil-working implements for subsoil loosening showing part of an implement frame with tool units having carrying arms powered raised and lowered, and spike articulation assemblies hinged thereto.

Referring now to the FIGs. there is illustrated in each case a side view transversely to the direction of travel of the implement showing the essential components on two different embodiments of a soil-working implement for subsoil loosening. Well documented in prior art are further components as are typical for such implements as recited in the background description, but which are omitted for a better overview. As a rule the soil-working implements involved feature a plurality of tool units arranged distributed transversely to the direction of travel of the soil-working implement. A view in perspective of one such distribution is evident, for example, from the German patent application DE 10 2004 018 101 A1, incorporated herein by reference, to which express reference is made as to further details of the soil-working implements involved presently.

The soil-working implements 1 and 2 comprise for hitching to a traction vehicle an implement frame 20 designed to travel over the soil 22 in the travel direction 23 by means of a roller 21.

Provided envisaged extending into the plane of illustration of the FIGs. is an inline arrangement of tool units 24 each configured identical to the other, but only one of which is shown in the FIGs. Each tool unit 24 has a carrying arm 25 which, for example, may be just a single rod, but which preferably is composed of a plurality of parallel rods coupled to each other, for example by being welded to each other comprising each carrying arm 25. At one end the carrying arm 25 is hinge mounted about a first pivot axis 26 directly or indirectly at the implement frame 20 such that the first pivot axis 26 is fixedly located relative to the implement frame 20. Engaging the carrying arm 25 is a driving means 27 featuring a crank assembly 28 and a crank connecting assembly 29 which pivotingly raises and lowers the carrying arm 25 about the first pivot axis 26. Pivotably hinged to the front end of the carrying arm 25 is a means for articulatingly positioning the spikes in the form of a tool holder 30 relative to the carrying arm 25 about a second pivot axis 31, resulting in the second pivot axis 31 and the tool holder 30 being raised and lowered with the carrying arm 25. Fixedly but removably secured to the tool holder 30 is a spike 32 for spiking the soil 22.

The crank assembly 28 comprises a crankshaft 34 mounted to rotate about an axis of rotation 36 on the implement frame 20 and features for each tool unit 24 a crankshaft journal 38 arranged eccentrically thereto. This rotational motion of the crankshaft journal 38 belonging to the tool unit 24 as shown is represented in the drawings by a dot-dashed line 40.

The crank connecting assembly 29 engages by its one end the crankshaft journal 38 and by its other end the carrying arm 25 for rotation and pivoting action in each case. Articulation of the carrying arm 25 is depicted in the example aspects as being concentric to the articulation of the tool holder 30, but this is not a mandatory requirement. It is in this way that the spike articulation assembly 30 is joined to the crank assembly 28 so that it can be raised and lowered. To sufficiently power the tool holder to spike the tool 32 the means for connecting the crank is connected substantially rigid or relatively stiffly. However, the crank connecting assembly 29 features an uncoupling assembly 42 for pliant response of the tool holder 30 contrary to a powered motion at least when overloaded.

For this purpose the crank connecting assembly 29 is not configured as a rigid drive rod, as in prior art, it instead comprising a first drive member 44 rotatably connected to the crankshaft journal 38 and a second drive member 46 hinge mounted at the tool holder 30 or carrying arm 25. The uncoupling assembly 42 interconnects the two drive members 44, 46 to permit the carrying arm 25 respectively the tool holder 30 to be normally powered via the crank assembly 28 whilst allowing for a rotational motion of the two drive members 44, 46 at least when overloaded.

In the first embodiment of a soil-working implement as shown in FIG. 1 the first drive member 44 takes the form of a first rod element 48 and the second drive member 46 takes the form of a second rod element 50. The two rod elements 48, 50 are pivotably interconnected by means of a pin 52 at their ends facing each other. In the normal operating position as indicated by the full lines in FIG. 1 the two rod elements 48, 50 form an obtuse angle to each other and are arrested in this position by a latch 54.

When in this embodiment the spike 32 comes up against an obstacle in the soil 22 during spiking, the latch 54 releases when a critical force is exceeded, allowing the two rod elements 48, 50 to collapse towards each other as indicated by the dot-dash lines in FIG. 1. Relatching can then be reinstated with the spike lifted by a force being exerted in the direction of “thru” on the connection 56 between the two rod elements 48, 50.

Referring now to FIG. 2 there is illustrated how in a second embodiment of a soil-working implement the crank connecting assembly 29 is engineered as a telescopic rod, both parts of which are formed by the two drive members 44, 46. The uncoupling assembly 42 comprises a damper in the form of a strong compression spring 58 mounted biased in a sleeve 60.

The compression spring 58 is so stiff that normal forces powering the implement are transmitted essentially unchanged from the crankshaft journal 38 to the tool holder 30. But as soon as the spike 32 comes up against a hard obstacle the compression spring 58 complies in thus damping the jolt.

Instead of the compression spring 58 various other forms of a spring may be employed in the embodiments (not shown), for example an elastomeric member or a torsion spring which in a design simulated in a first embodiment is housed in the connection 56.

In a further embodiment (again not shown) the two rod elements 48, 50 are interconnected by a shear pin instead of by the latch 54, the shear pin being engineered to snap when overloaded to result in compliance in the same way as explained with reference to the latch 54, except that in this case the shear pin needs to be replaced by a new one when reconnecting the rod elements 48, 50.

### List of Reference Numerals

1 soil-working implement (first embodiment)

2 soil-working implement (second embodiment)

20 implement frame

21 roller

22 soil

23 travel direction

24 tool unit

25 carrying arm

26 first pivot axis

27 driving means

28 crank assembly

29 crank connecting assembly

30 tool holder (spike articulation assembly)

31 second pivot axis

32 spike

34 crankshaft

36 axis of rotation

38 crankshaft journal

40 rotational motion

42 uncoupling assembly

44 first drive member

46 second drive member

48 first rod element

50 second rod element

52 pins

54 latch

56 connection

58 compression spring (damper)

60 sleeve

1. A soil-working implement for subsoil loosening, having:
a series of carrying arms, of which each arm is mounted by way of a first portion, in particular a first end portion, on an implement frame or an implement chassis such that each arm is pivotably mounted for raising and lowering about a first pivot axis,
a crankshaft with at least one crankshaft journal;
at least one spike articulation assembly for articulating a spike on a second portion, in particular a second end portion, of each carrying arm, and
at least one crank connecting assembly per carrying arm, this assembly connecting the spike articulation assembly to the at least one crankshaft journal of the crankshaft for the purpose of activating raising and lowering guided by the carrying arm, wherein
the crank connecting assembly has an uncoupling assembly which, at least when overloaded between the crankshaft and the spike articulation assembly, allows relative movement of the spike articulation assembly in the direction of the crankshaft journal.

2. The soil-working implement as set forth in claim 1, wherein
the crank connecting assembly comprises a first drive member rotatably hinged to the crankshaft journal and a second drive member pivotably hinged to the carrying arm 25, and
the first and second drive member are coupled to each other by the uncoupling assembly such that until overloaded they are connected substantially rigid or stiffly, but are movable relatively to each other when overloaded.

3. The soil-working implement as set forth in claim 2, wherein the two drive members are shiftably telescopically nested when overloaded.

4. The soil-working implement as set forth in claim 2, wherein the two drive members are articulated to each other such that they are pivotable to each other when overloaded.

5. The soil-working implement as set forth in claim 1, wherein the uncoupling assembly comprises a damper element via which at least part of the driving force is transmitted from the crankshaft journal to the carrying arm.

6. The soil-working implement as set forth in claim 5, wherein the damper element comprises a spring and/or an elastomeric member.

7. The soil-working implement as set forth in claim 1, wherein the uncoupling assembly comprises a link which snaps or remains permanently deformed when overloaded via which at least part of the driving force is transmitted from the crankshaft journal to the carrying arm.

8. The soil-working implement as set forth in claim 1, wherein the uncoupling assembly comprises a latch releasing when overloaded via which at least part of the driving force is transmitted from the crankshaft journal to the carrying arm.

9. The soil-working implement as set forth in claim 1,
wherein the spike articulation assembly is pivotably hinged about a second pivot axis at the carrying arm relative to the carrying arm such that a spike secured to the spike articulation assembly is rendered spikeable into the soil when the associated carrying arm is lowered and the spike articulation assembly is pivoted in the direction of travel relative to the carrying arm at least with the spike spiked and on further travel of the soil-working implement.

10. The soil-working implement as set forth in claim 1, wherein said second portion of each carrying arm is a second end portion of each carrying arm.

11. The soil-working implement as set forth in claim 5, wherein the damper element comprises a compression spring.
